(19) United States
(12) Patent Application Publication
(10) Pub. No.: US 2009/0147090 A1
(43) Pub. Date: Jun. 11, 2009

(54) IMAGE PROCESSING DEVICE

(76) Inventor: Takanori Miki, Kanagawa (JP)

Correspondence Address: David A. Novais;Patent Legal Staff, Eastman Kodak Company, 343 State Street, Rochester, NY, 14650-2201, US

(21) Appl. No.: 12/041,698

(22) Filed: Mar. 4, 2008

(30) Foreign Application Priority Data
Dec. 7, 2007 (JP) 2007-317262

(51) Int. Cl. H04N 5/232

(52) U.S. Cl. 348/208.1; 348/208.6; 348/E05.046

(57) ABSTRACT

There is provided an image processing device that enables acquisition of a superior image even when camera movement arose. A digital camera has an angular velocity sensor for detecting amounts of camera movement arising during photographing. A control parameter computation section computes, from a result of detection performed by the angular velocity sensor, an edge enhancement coefficient by means of which a decrease arises in a degree of enhancement in a band where the signal component of the original image obtained in an ideal no-camera-movement, noiseless state has decreased for reasons of the camera movement. Moreover, there is also computed a quantization table by means of which an increase arises in a quantization value in a band where the signal component of the original image has decreased.

### CROSS REFERENCE TO RELATED APPLICATIONS

This application claims priority to Japanese Patent Application No. 2007-317262 filed on Dec. 7, 2007, which is incorporated herein by reference in its entirety.

### FIELD OF THE INVENTION

The present invention relates to an image processing device that subjects to predetermined image processing captured image data acquired by means of photographing.

### BACKGROUND OF THE INVENTION

A digital camera, or the like, is equipped with an image processing device that subjects to edge enhancement processing or compression processing a digital image acquired by means of photographing. In such an image processing device, a value of a parameter called an edge enhancement kernel that shows a relationship between a frequency and the amount of enhancement used for edge enhancement processing and a value of a parameter used at the time of compression processing, such as a quantization value, are determined according to an empirical value.

Both the quantization value and the value of an image processing parameter, such as the edge enhancement kernel, are set on the premise that no hand movements (hereinafter called “camera movement”) exists in a captured image. Degradation of an image due to camera movement has hitherto been compensated for by performing custom-designed camera shake compensation processing. In other words, camera shake compensation processing and other image processing have heretofore been taken as totally-different processing operations that are irrelevant to each other.

However, presence or absence of camera movement greatly affects results of edge enhancement processing and compression processing. For instance, there are cases where a signal component of an original image to be photographed (an original image) is significantly reduced for reasons of camera movement, thereby deteriorating a signal-to-noise ratio. If edge enhancement is performed when the signal-to-noise ratio is deteriorated in the same fashion as in the case where no camera movement have arisen, noise is enhanced, which contrarily degrades an image. Even in relation to quantization performed during compression, if an area having a deteriorated signal-to-noise ratio is quantized by using the same quantization value as that used for an area having a superior signal-to-noise ratio, noise will remain in a compressed image (to be precise, a restoration image that has been restored by subjecting a compression image to expansion) and still be a cause of degradation of an image.

### SUMMARY OF THE INVENTION

Accordingly, the present invention provides an image processing device capable of acquiring a superior image even when camera movement arose.

According to the present invention, there is provided an image processing device that subjects captured-image data acquired by means of photographing to predetermined image processing, the device comprising:

a detection unit that detects amounts of camera movement of an image-capturing system during photographing;

a control parameter computation unit that computes a control parameter used for image processing and that computes, from the amounts of camera movement detected by the detection unit, a control parameter which enables lessening of influence of noise in a band where a signal component of an original image has decreased for reasons of the camera movement; and

an image processing unit that subjects the captured-image data to prescribed image processing by use of the computed control parameter.

In a preferred mode, the control parameter computation unit preferably computes, as the control parameter, at least an edge enhancement coefficient showing a degree of enhancement in edge enhancement processing in each frequency band. In this case, the control parameter computation unit preferably computes, from the detected amounts of camera movement, an edge enhancement coefficient by means of which a decrease arises in a degree of enhancement in a band where the signal component of the original image has decreased for reasons of the camera movement. Moreover, the image processing device preferably further comprises a PSF computation unit that computes, from the detected amounts of camera movement, a PSF showing an amount of movement of an image induced by camera movement; and a storage unit that stores, as a reference edge enhancement coefficient, an edge enhancement coefficient utilized in a state where no camera movement have arisen. The control parameter computation unit preferably computes an edge enhancement coefficient by means of subjecting the reference edge enhancement coefficient and the PSF to convolution integration. Further, the image processing unit preferably does not perform edge enhancement processing when the detected amounts of camera movement are a given level or more.

In another preferred mode, the control parameter computation unit computes, as the control parameter, a quantization table showing quantization values for respective frequency bands in quantization processing for compression processing. In this case, the control parameter computation unit preferably computes, from the detected amounts of camera movement, a quantization table by means of which an increase arises in a quantization value in a band where the signal component of the original image has decreased for reasons of the camera movement. Furthermore, the image processing device further comprises a PSF computation unit that computes, from the detected amounts of camera movement, a PSF showing an amount of movement of an image induced by camera movement; and a storage unit that stores, as a reference quantization table, a quantization table utilized in a state where no camera movement have arisen. The control parameter computation unit preferably computes a quantization table by means of computing, from the PSF, a degree of decrease in the signal component of the original image attributable to camera movement in each frequency band and compensating for the reference quantization table in order to increase the quantization value in a band where a greater degree of decrease is present.

In the foregoing image processing device, the image processing unit preferably performs camera shake compensation processing for compensating for degradation of an image attributable to camera movement after performance of compression processing of the captured-image data.

According to the present invention, a control parameter used for image processing is computed from amounts of camera movement, and hence a preferable image can be acquired even when camera movement arose.

The invention will be more clearly comprehended by reference to the embodiments provided below. However, the scope of the invention is not limited to the embodiments.

### BRIEF DESCRIPTION OF THE DRAWINGS

Preferred embodiments of the present invention will be described in detail by reference to the following drawings, wherein:

FIG. 1 is a block diagram showing the configuration of a digital camera serving as an embodiment of the present invention;

FIG. 2 is a graph showing a coring characteristic value employed in a coring operation;

FIG. 3 is a graph showing a frequency response of a reference edge enhancement coefficient;

FIG. 4 is a graph showing an example of the frequency response of the reference edge enhancement coefficient;

FIG. 5 is a graph showing a frequency response of a captured image;

FIG. 6 is a graph showing a frequency response of an original image;

FIG. 7 is a graph showing a frequency response of a PSF (Point Spread Function);

FIG. 8 is a graph showing a frequency response of a degraded image;

FIG. 9 is a graph showing a frequency response of a compensated edge enhancement coefficient;

FIG. 10 is a graph showing a frequency response of another reference edge enhancement coefficient;

FIG. 11 is a graph showing a frequency response of another PSF;

FIG. 12 is a graph showing a frequency response of another compensated edge enhancement coefficient;

FIG. 13A shows a reference quantization table, and FIG. 13B shows a compensated quantization table;

FIG. 14A shows a result of DCT (Discrete Cosine Transform) of the PSF, and FIG. 14B is a table of compensation coefficients; and

FIG. 15 shows a compensated quantization table.

### DETAILED DESCRIPTION OF THE INVENTION

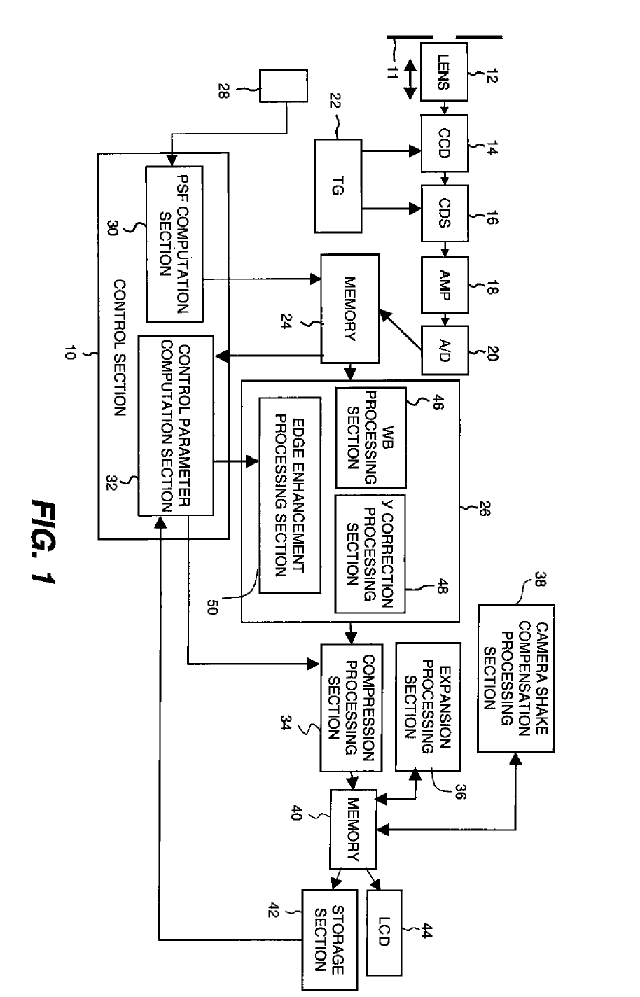

Embodiments of the present invention will be described hereunder by reference to the drawings. FIG. 1 is a block diagram showing the configuration of a digital camera serving as an embodiment of the present invention. The digital camera subjects to image processing, such as edge enhancement processing and compression processing, image data acquired by means of photographing, and saves the processed data as compressed image data in a storage section 42. In the present embodiment, a value of a control parameter used at the time of image processing is variably adjusted according to an amount of camera shake arose during photographing operation. Individual sections of the digital camera will be described in detail hereunder.

Field light entered by way of an aperture diaphragm member 11 and a lens 12 focuses on a CCD 14 serving as an image-capturing device. An aperture ratio of the aperture diaphragm 11 and the amount of movement of the lens 12 are controlled by means of a control section 10 made up of CPUs and the like. The CCD 14 converts the input field light into an electric signal and outputs the thus-converted signal as captured-image data. Timing of photoelectric conversion performed by the CCD 14 is controlled by the control section 10 by way of a timing generator TG) 22. In order to acquire a preview image to be displayed on an LCD 44, the CCD 14 performs accumulation and discharge of electric chares at a given interval all the time. Upon receipt of an instruction for the capture of an image from the user, photoelectric conversion for acquiring a preview image is suspended, and electric charges are accumulated by consumption of an exposure time required to capture an image, and the electric charges are then discharged.

After undergoing predetermined analogue signal processing performed by a double correlated sampling (CDS) circuit 16 and amplification processing performed by an amplifier circuit (AMP) 18, an electric signal output from the CCD 14 is converted into digital data by means of an analogue-to-digital (AID) converter 20. The digital data acquired through conversion are temporarily stored in memory 24 as captured-image data.

A PSF computation section 30 computes a PSF (Point Spread Function), which shows an amount of camera shake arose during photographing, from angular velocity detected by an angular velocity sensor 28 formed from a gyroscope. The PSF is a parameter showing an amount of movement of an image caused by camera movement that is derived from the angular velocity detected by the angular velocity sensor 28 and image magnification power of an image-capturing system. The computed PSF is temporarily stored in the memory 24 along with captured-image data. The PSF is utilized for computing control parameters used for edge enhancement processing and compression processing, which will be described later, as well as for camera shake compensation processing for compensating for degradation of an image due to camera movement.

A control parameter computation section 32 computes from the PSF temporarily stored in the memory 24 control parameters used for edge enhancement processing and compression processing; specifically, an edge enhancement coefficient and a quantization table. A specific method for computing these two control parameters will be described in detail later.

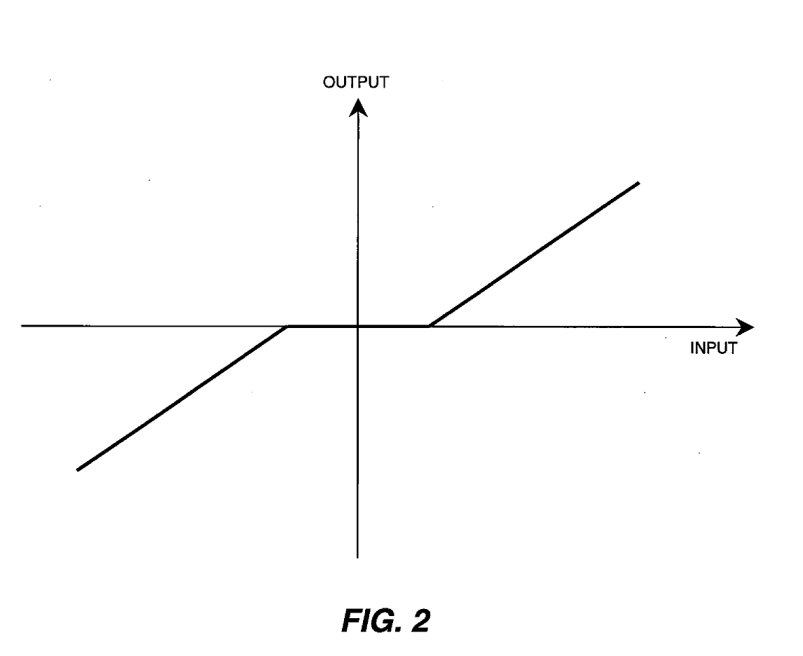

The image processing section 26 is provided with a white balance (WB) processing section 46 and a γ compensation processing section 48, and subjects the captured-image data temporarily stored in the memory 24 to known image processing. The image processing section 26 is also equipped with an edge enhancement processing section 50 that performs edge enhancement processing for enhancing sharpness of an image. As will be described in detail later, the edge enhancement processing section 50 first subjects the captured-image data and an edge enhancement coefficient computed by the control parameter computation section 32 to convolution integration, thereby enhancing an edge component included in an image. Subsequently, coring processing for eliminating signals whose amplitudes are smaller than a given threshold value is performed by use of a coring conversion characteristic value such as that shown in FIG. 2.

The image data having undergone necessary processing in the image processing section 26 are compressed to a JPEG format by means of a compression processing section 34 and stored as compressed image data in the storage section 42. At that time, a value of a corresponding PSF is also stored in association with the compressed image data by means of a method for writing the value into a header of the compressed image data or a like method. Although the quantization table computed by the control parameter computation section 32 is utilized during compression processing, the table will also be described in detail later.

When reproduction of a compressed image stored in the storage section 42 is instructed by the user, an expansion processing section 36 expands and restores the compressed image data. When a user's instruction is provided at this time, a camera shake compensation processing section 38 subjects the expanded, restored image data to camera shake compensation processing. The PSF stored in association with the compressed image data is used at the time of compensation of camera movement.

For instance, a steepest-descent method has hitherto been known as a camera shake compensation technique using a PSF, and the outline of the method is as follows. Specifically, ∇J of a captured image is computed, where J is the amount of evaluation of a common inverted filter. Provided that a degraded image, which is a captured image, is taken as G; that a restored image is taken as F; and that a deterioration function (PSF) is taken as H, J is expressed as follows:

J=∥G−HF∥²

The expression signifies that the amount of evaluation J is determined by the magnitude of a difference between an image HF acquired by subjecting the restored image F to the deterioration function H and the actual degraded image G. When the image is correctly restored, HF=G is theoretically achieved, so that the amount of evaluation comes to zero. The smaller the amount of evaluation J becomes, the better the restored image F is restored. Under the steepest-descent method, repeated calculation is iterated until the magnitude of ∇J that is a gradient of the amount of evaluation J; namely, the square of a norm of ∇J, becomes equal to or smaller than a threshold value. Repeated calculation is completed at a point in time when the square of the norm comes to the threshold value or less, thereby acquiring a restored image F. The amount of evaluation J is computed by use of the captured image (the degraded image G), the restored image F, and the PSF, that is, the deterioration function H, and ∇J is further computed. The thus-computed square of the norm of ∇J is compared with the threshold value, thereby determining whether or not the square is the threshold value or less. When the square of the norm is the threshold value or less, the norm of ∇J is deemed to converge at an optimum solution in a sufficiently-small manner, and iterative computation is completed. In the meantime, when the square of the norm of ∇J exceeds the threshold value, restoration of the image is determined not yet to be sufficient, and repeated calculation is continued. As a matter of course, the camera shake compensation method using a PSF is not limited to the steepest-descent method, and another method may also be used.

As is obvious from the descriptions provided thus far, the present embodiment adopts so-called post processing in which camera shake compensation processing is performed after compression processing. By adoption of post processing, the user can freely determine whether or not camera shake compensation is required. Specifically, many related-art digital cameras perform edge enhancement processing and compression processing after performed camera shake compensation processing. However, much of related-art camera shake compensation processing is automatically performed in accordance with the value of the PSF and is not performed in response to the user's instruction. For this reason, there are cases where camera shake compensation processing is performed against the user's intension, whereby an image contrasts with an image intended by the user. Even when such an image differing from the user's intension is subjected to edge processing, which is nonlinear processing, and compression processing and when the processed image is stored as a JPEG image, an image, which would otherwise be obtained before camera shake compensation processing, cannot be restored again.

In order to solve the problem, a conceivable method is to display on the LCD 44 an image which is not yet subjected to edge processing, compression processing, and the like, to thus receive an instruction from the user as to whether or not to perform camera shake compensation. However, the LCD 44 incorporated in a digital camera is usually of a small size (has a small number of pixels) in many cases, and the user encounters difficulty in clearly ascertaining the degree of influence of camera movement at the sight of a display on the LCD 44. Another conceivable method is to save image data, which are not yet subjected to edge processing or compression processing, in the storage section 42. However, in that case, the amount of data to be saved becomes large, and hence the method is not realistic. For these reasons, in the present embodiment, even when camera movement arose during photographing, camera shake compensation is not performed before compression processing, and camera shake compensation is performed after compression processing. By means of such a configuration, a determination can be made, according to the user's desire, as to whether or not camera shake compensation is performed while the amount of image data to be saved is reduced.

Incidentally, when post processing is adopted, the influence of camera movement still exists in the image data that are objects of edge enhancement processing and compression processing. There are occasions where the influence of the camera movement adversely affect edge enhancement processing and compression processing. However, control parameters which have heretofore been used for edge enhancement processing and compression processing are defined regardless of presence or absence of camera movement. Adjusting the control parameters according to the state of occurrence of camera movement has not been performed. Consequently, there arises a problem of image quality achieved after processing being degraded according to the state of occurrence of camera movement.

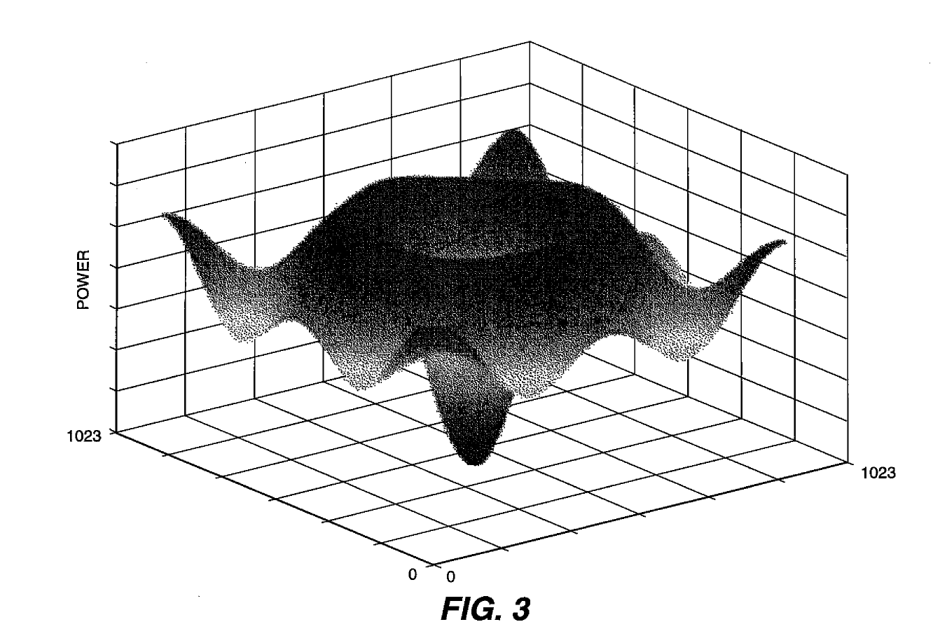

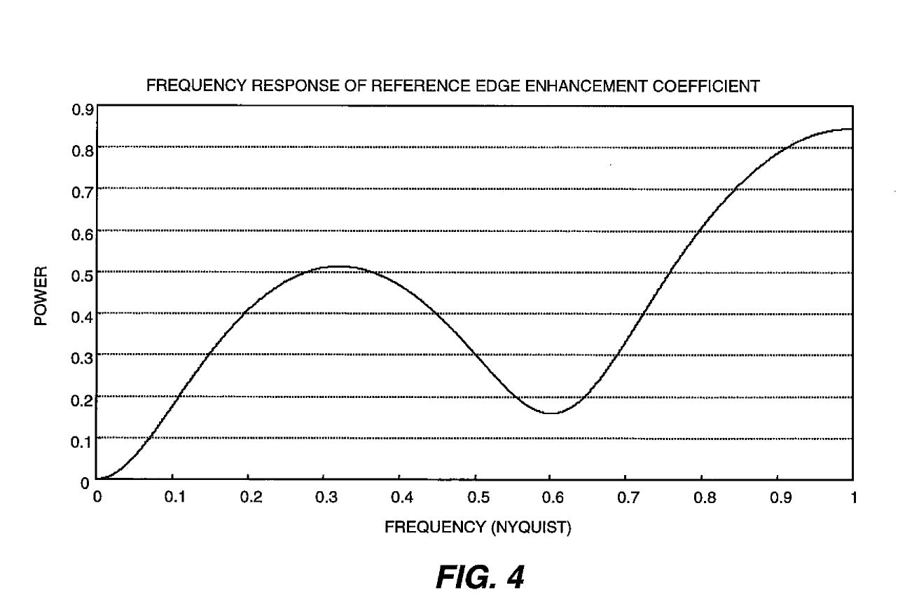

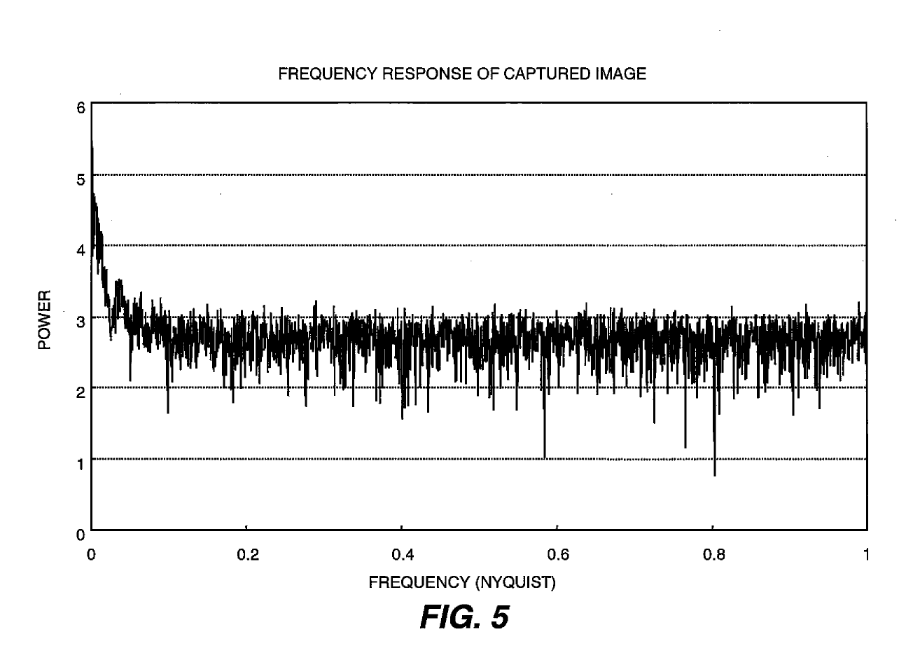

The problem is described by taking the case of edge enhancement processing as an example. FIG. 3 is a graph showing a frequency response of an edge enhancement coefficient which has hitherto been frequently used (hereinafter called a “reference edge enhancement coefficient”). FIG. 4 shows, in the form of a two-dimensional graph, an extracted portion of the reference edge enhancement coefficient shown in FIG. 3. FIG. 5 is a graph showing a frequency response of a captured image corresponding to the reference edge enhancement coefficient shown in FIG. 4. Namely, each of the edge enhancement coefficient and an image signal has three axes; namely, a horizontal axis, a vertical axis, and an axis of power, and is originally expressed through use of a three-dimensional graph as shown in FIG. 3. However, for the sake of convenience of explanation, an explanation is provided by use of an extracted portion of the three-dimensional graph that is expressed in the form of a two-dimensional graph, as shown in FIGS. 4 and 5. In FIGS. 3 through 12, all vertical axes are common logarithmic axes.

At the time of edge enhancement processing, the reference edge enhancement coefficient shown in FIG. 4 and a captured image signal shown in FIG. 5 have hitherto been subjected to convolution integration, thereby enhancing an edge component. Subsequently, signals which are equal to or less than a given threshold value are eliminated in accordance with the coring characteristic shown in FIG. 2, thereby diminishing noise.

Although the reference edge enhancement coefficient is originally set to a value which enables enhancement of an edge component, there have been occasions where noise rather than an edge component is enhanced when camera movement arise. For instance, the reference edge enhancement coefficient shown in FIG. 4 has a characteristic which especially enhances a high-frequency band. When a signal-to-noise ratio of the high-frequency band to be enhanced is degraded for reasons of camera movement, noise is enhanced. In consequence, image quality is further degraded by performance of edge enhancement processing.

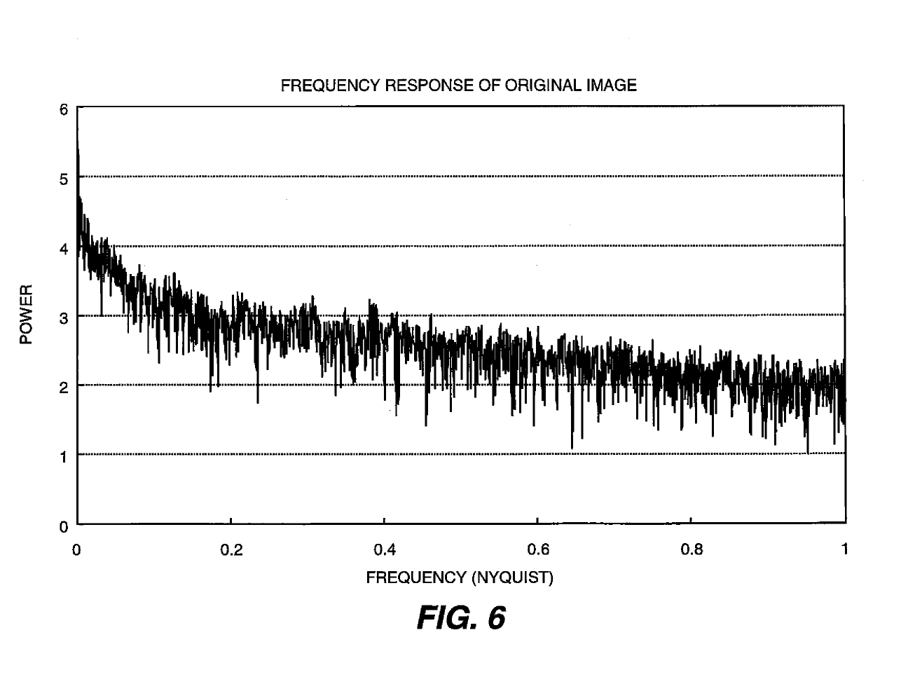

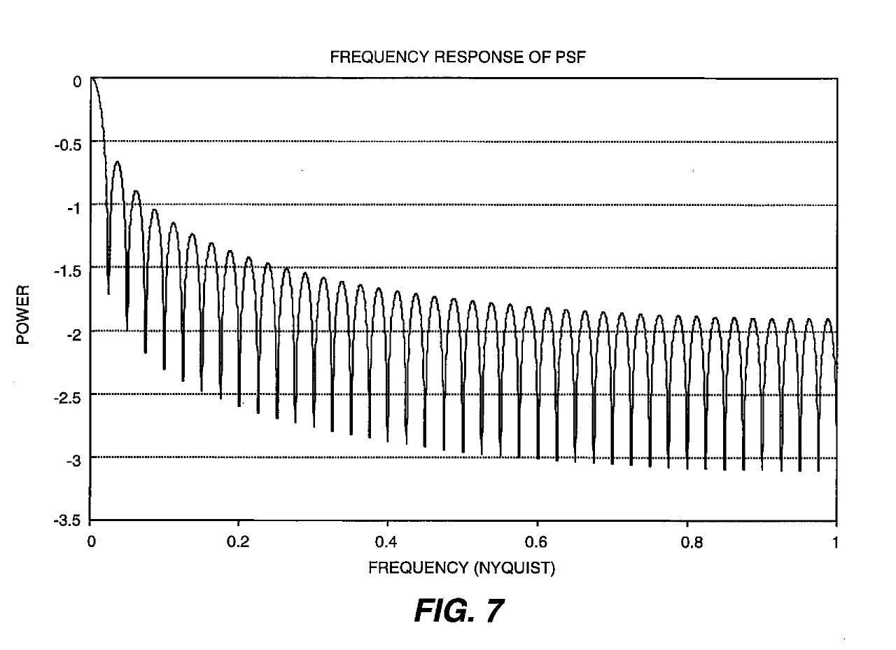

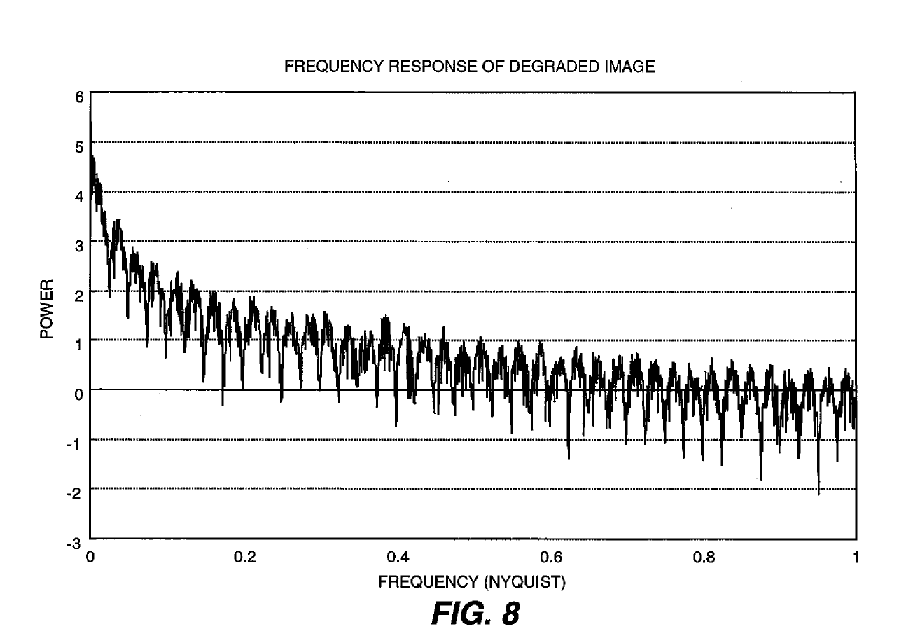

An explanation is given by reference to a specific example. Consideration is now given to a case where an original image exhibiting a frequency response, such as that shown in FIG. 6, is captured. Now, the original image means an image acquired in an ideal state which is free from camera movement or noise. The frequency response of a PSF of camera movement arose during capture of the original image is assumed to exhibit smaller power with an increase in frequency as shown in FIG. 7. An image degraded by camera movement becomes equivalent to a result of convolution integration of an original image and a PSF. Therefore, a signal of an original image decreases in a band where the power of the PSF is small. Since the power of the PSF decreases with an increase in frequency in the present embodiment, the power of the signal of the original image naturally decreases with an increase in frequency. As shown in FIG. 8, the frequency response of the degraded image exhibits smaller power in a higher frequency band.

An image finally captured by means of photographing becomes equivalent to an addition of noise, such as CCD noise, to the degraded image. Noise to be added is usually white noise which exhibits a given level over the entire band. Therefore, a frequency response of a finally-obtained image signal is as shown in FIG. 5. Even though the signal of the original image in a high frequency band is significantly decreased for reasons of camera movement, noise to be added has a given level irrespective of camera movement. For this reason, in the present embodiment, the signal-to-noise ratio that is a ratio of the signal of the original image to noise can be said to be greatly deteriorated (decreased) because of camera movement in the high frequency band where the signal of the original image is decreased by camera movement.

When a reference edge enhancement coefficient that exhibits high power at a high frequency as show in FIG. 4 is applied to the image whose signal-to-noise ratio in the high frequency band is deteriorated, noise is enhanced in the high frequency band, which consequently results in a decrease in image quality of an acquired image.

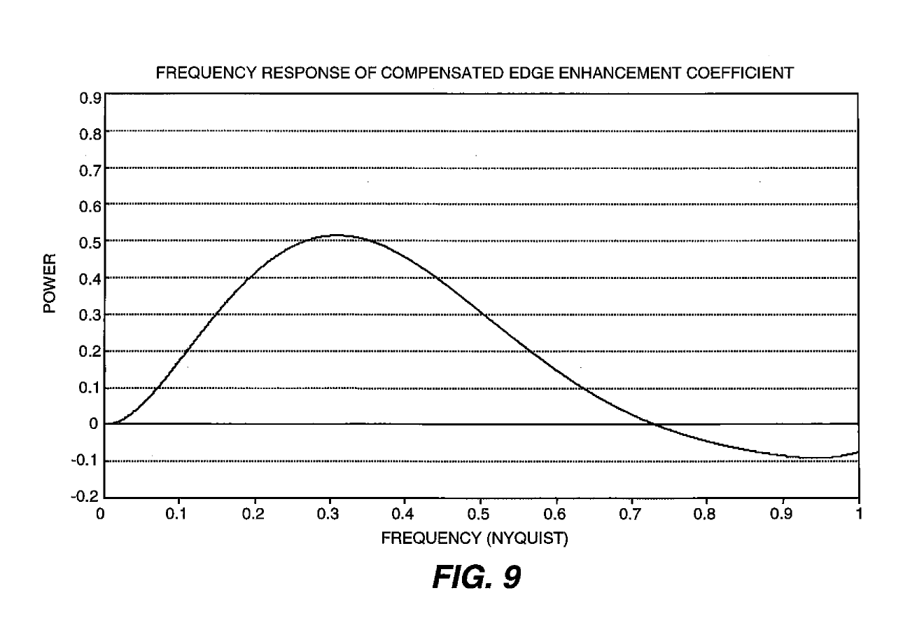

Therefore, in the present embodiment, an attempt is made to further enhance image quality by variably adjusting the edge enhancement coefficient in accordance with amounts of camera movement (PSF). For instance, when a PSF, such as that shown in FIG. 7, is acquired, the power of the original image in a high frequency band can be assumed to be decreased. Consequently, in this case, the power of the edge enhancement coefficient achieved in the high frequency band where a decrease in the signal of the original image is expected is decreased as shown in FIG. 9. As a result, unwanted enhancement of noise is prevented, thereby enabling a further increase in image quality.

Various forms are conceivable as the method for variably adjusting an edge enhancement coefficient. However, in the present embodiment, the edge enhancement coefficient is compensated along the following procedure. First a reference edge enhancement coefficient (the edge enhancement coefficient shown in FIGS. 3 and 4), which is used when no camera movement are present is previously stored in storage section 42. The control parameter computation section 32 computes, as a compensated edge enhancement coefficient, a value obtained by convolution integration of the reference edge enhancement coefficient and a PSF. The edge enhancement processing section 50 performs edge enhancement processing through use of the thus-computed compensated edge enhancement coefficient.

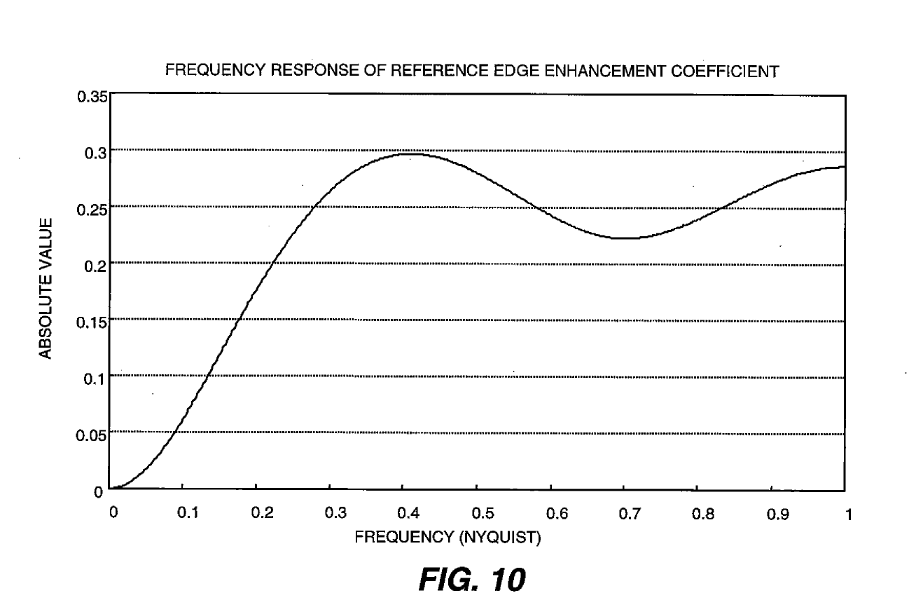

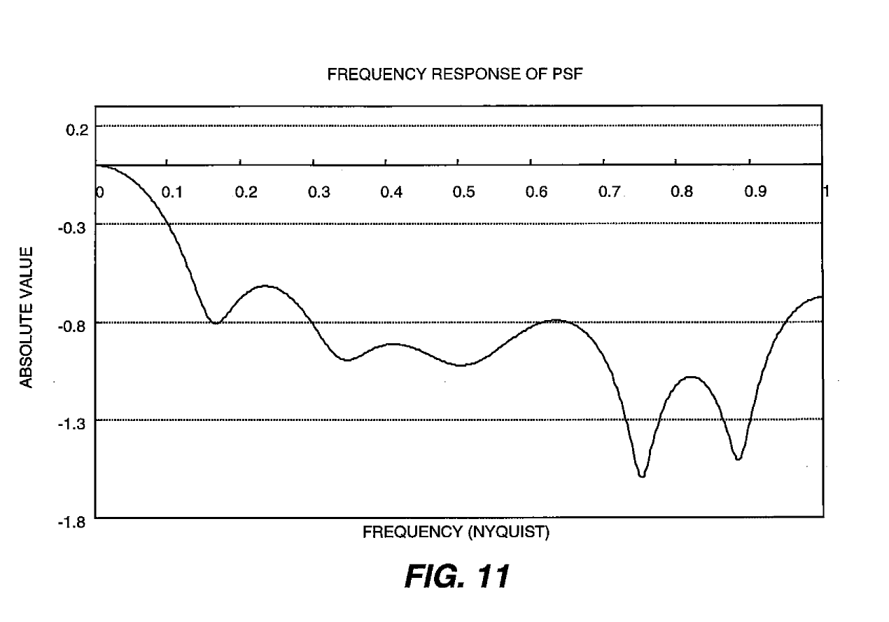

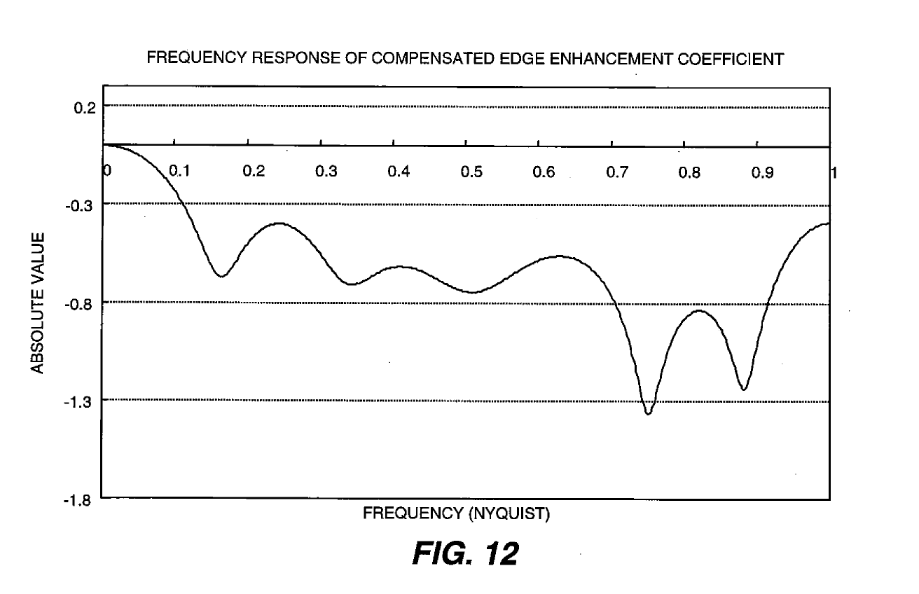

For example, the reference edge enhancement coefficient, such as that illustrated in FIG. 10, is assumed to be stored in the storage section 42, and the PSF computed from amounts of camera movement arose during photographing is assumed to exhibit a frequency response such as that shown in FIG. 11. In this case, the control parameter computation section 32 subjects the reference edge enhancement coefficient shown in FIG. 10 and the PSF shown in FIG. 11 to convolution integration, thereby computing a resultant edge enhancement coefficient shown in FIG. 12 as a compensated edge enhancement coefficient. According to this method, the degree of enhancement (power of the edge enhancement coefficient) achieved in the band where the signal of the original image is decreased for reasons of camera movement (in other words, a band where the power of the PSF is small) is reduced, and hence unwanted enhancement of noise, which would otherwise be caused by edge enhancement processing, can be prevented. As a result, even when camera movement arose, image quality can be enhanced.

The procedure for computing an edge enhancement coefficient described above is a mere example. Naturally, the edge enhancement coefficient may also be compensated for along another procedure. Although the reference edge enhancement coefficient is compensated in accordance with the value of the PSF in the present embodiment, a plurality of types of edge enhancement coefficients, for example, may also be previously prepared, and an optimum one may be selected from the plurality of edge enhancement coefficients in accordance with the value of the PSF. Moreover, when the amounts of camera movement are greater than a given reference value, edge enhancement processing itself may also be omitted.

A relationship between compression processing and camera movement will now be described. In the present embodiment, the image data having undergone image processing, such as edge enhancement processing and γ compensation processing, are compressed and saved by means of a JPEG format. During JPEG compression processing, an image is divided into blocks of fixed size (e.g., 8×8 pixels). Frequency components G(k, l) (“k” designates a horizontal direction; “l” designates a vertical direction; and “k” and “l” range from 0 to 7) of the 8×8 pixels are acquired on a per-block basis by use of a discrete cosine transform (DCT). Subsequently, the frequency components G (k, l) are divided by corresponding quantization values Q (k, l) defined in a quantization table and rounded up. Resultant values are subjected to entropy coding by means of a Huffman code, to thus become compressed. Entropy coding is to compress data by assigning codes of different lengths according to the degree of the probability of occurrence of data.

A related-art quantization table defining the step size of quantization has been constant regardless of presence or absence of camera movement. Therefore, there are occasions where a band where a signal-to-noise ratio is deteriorated for reasons of camera movement is also quantized uselessly by means of a small quantization value. In consequence, noise still exists uselessly after quantization, which may result in degradation of image quality.

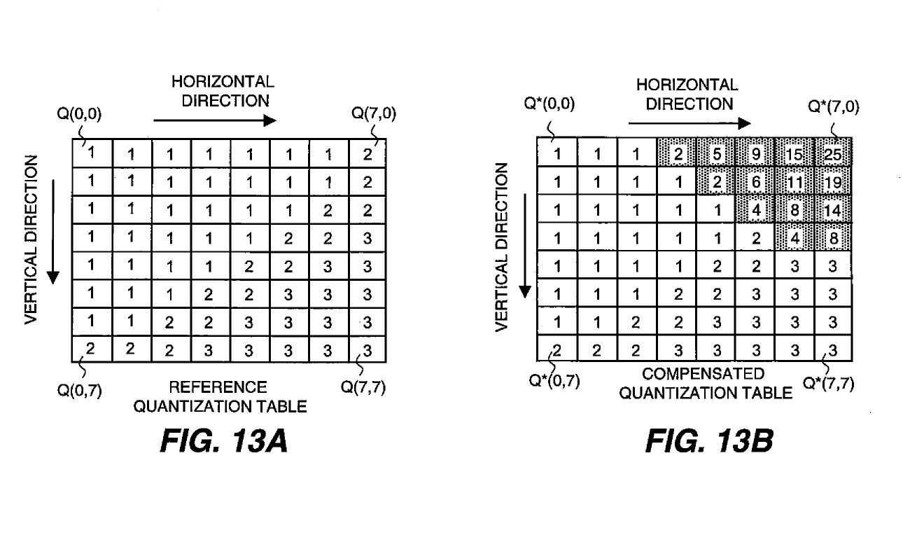

In order to address the problem, the quantization table is changed as appropriate in accordance with the amount of camera shake (PSF). This will be described by reference to a specific example. FIG. 13A is a view showing an example quantization table that has hitherto been used frequently. Through JPEG compression processing, a quantization value (step size) of a high-frequency wave is increased (i.e., the number of gradations becomes smaller) by utilization of a human's visual characteristic of hardly perceiving unnaturalness in an area where minute changes arise even with a smaller number of gradations. Therefore, as shown in FIG. 13, quantization values [e.g., Q(7, 7) or the like] achieved at high frequencies are increased in the quantization table that has hitherto been used frequently.

However, as described in connection with edge enhancement processing, a signal component of the original image is significantly reduced for reasons of camera movement according to the circumstances where the camera movement have arisen, and a ratio of a signal component of the original image to a noise component, such as CCD noise arising regardless of camera movement, may decrease drastically. For instance, when camera movement arise in the horizontal direction, a decrease arises in signal components of the original image achieved at high frequency bands [G(7, 0) and G(7, 1), or the like] in the horizontal direction. Even when the bands where a decrease has arisen in the signal components of the original image are quantized by means of a small quantization value, quantization of the bands can be said to be useless because noise components are only left. Accordingly, in the present embodiment, when camera movement arise in the horizontal direction; in other words, when signal components of the original image achieved at high-frequency bands in the horizontal direction are decreased for reasons of camera movement, quantization values [hatched in FIG. 13B] in the quantization table achieved at high-frequency bands in the horizontal direction are increased as shown in FIG. 13B, thereby increasing gradations achieved in the bands. As a result, more efficient compression becomes feasible. Moreover, generation of unnecessary residual noise is prevented, and image quality achieved during compression of an image can be enhanced.

Various forms are conceivable in connection with the method for changing the quantization table. However, in the present embodiment, the quantization table corresponding to amounts of camera movement is computed along the following procedures. First, a quantization table used for a case where no camera movement are present (i.e., a quantization table shown in FIG. 13A) is stored in advance in the storage section 42 as a reference quantization table. The control parameter computation section 32 computes a frequency component P(k, l) of the 8×8 pixels while taking the PSF computed by the PSF computation section 30 as a DCT. Subsequently, P(0, 0) of the frequency components of the 8×8 pixels is considered to be a reference, and a value Pa(k, l)={|P(0, 0)|/|P(k, l)|} showing a ratio of the absolute value of the frequency component P(k, l) to P(0, 0) is computed. Subsequently, the value Pa(k, l) acquired through computation is rounded up and clipped by 255. A resultant value is thus computed as a compensation coefficient P*(k, l). The compensation coefficient serves as a parameter showing the degree of a decrease in a signal component of the original image in each band due to camera movement. The compensation coefficient P*(k, l) showing the degree of a decrease and the quantization value Q(k, l) defined in the reference quantization table are summated in connection with each corresponding band and clipped by means of 255. A resultant value is thus computed as a compensated quantization value Q*(k, l)=Q(k, l)×Pb(k, l) [in the case of Q*(k, l)>255, the value is forcefully converted into Q*(k, l)=255].

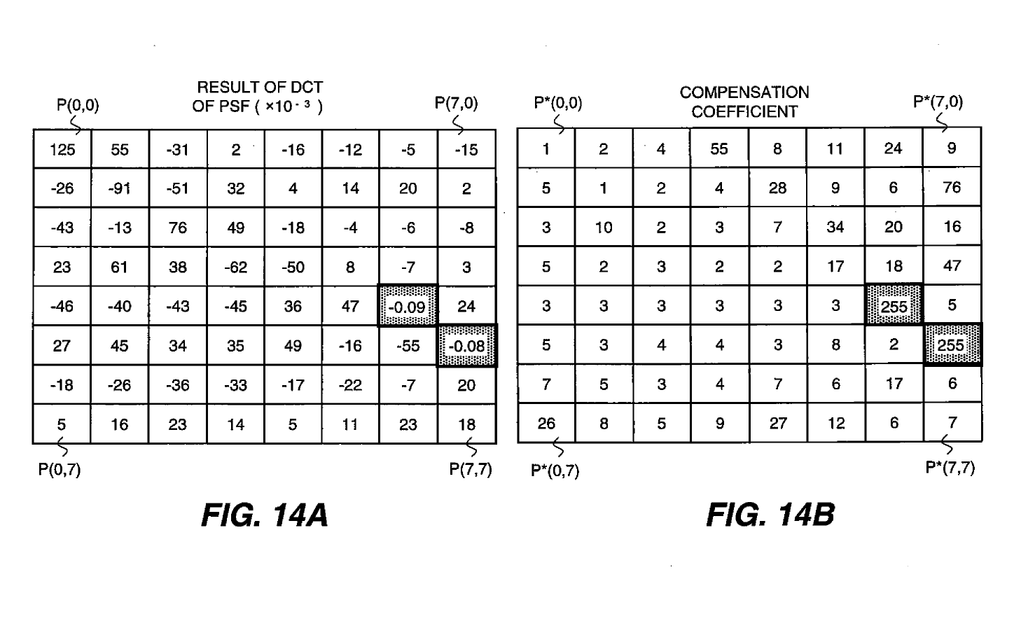

The method for computing the quantization table is described by reference to a specific example. FIG. 14A is a table showing results P(k, l) of DCT of a PSF. When attention is paid to results of the DCT of the PSF, values of P(6, 4) and P(7, 5), which are hatched, are understood to be very small. In such a frequency band, the signal component of the original image significantly decreases for reasons of camera movement, and a signal-to-noise ratio of the signal component is deteriorated. Even in such a frequency band, performing quantization with fine gradation levels is useless, and residual noise is invited.

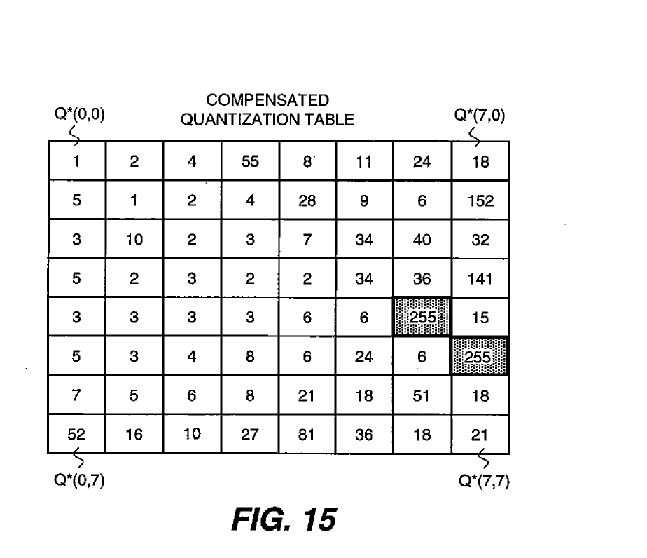

For this reason, the control parameter computation section 32 computes the compensation coefficient P*(k, l) along the previously-described procedures. FIG. 14B shows the compensation coefficient P*(k, l) obtained in the present embodiment. A value of the compensation coefficient P*(k, l) becomes greater in a band where the value of the P(k, l) becomes smaller than the value of the P(0, 0). Therefore, the value of the compensation coefficient P*(k, l) for a band where the frequency component of the PSF is small; in other words, a band where the signal component of the original image can be presumed to have significantly decreased for reasons of camera movement, becomes greater as in the case of the previously-described (6, 4) and (7, 5). A compensated quantization table Q*(k, l), which is acquired by summation of the compensation coefficient P*(k, l) and the reference quantization table Q(k, l) shown in FIG. 13A, is a table shown in FIG. 15. As is evident from FIG. 15, compensated quantization values Q*(k, l) achieved in (6, 4) and (7, 5), where the frequency component of the PSF is small, are greater than compensated quantization values acquired in other bands. Therefore, so long as quantization is performed by use of the compensated quantization values Q*(k, l), there is prevented useless quantization of, with fine gradation, a band where the signal component of the original signal has decreased for reasons of camera movement. Consequently, prevention of occurrence of residual noise as well as enhancement of compression can be achieved, and hence image quality of a compressed image can be enhanced.

The method for compensating for quantization values described herein is a mere example. Naturally, quantization values may also be compensated for by another method. For instance, a compensation coefficient for only a band where the absolute value of frequency component power of the PSF is equal to or less than a predetermined threshold value (e.g., 1×10⁻⁴) may also be computed in lieu of compensation coefficients of all of the bands which are computed as mentioned above, thereby compensating for a quantization value. Alternatively, selecting an optimum quantization table from a plurality of previously-prepared quantization tables in accordance with the value of a PSF instead of compensating for the reference quantization table may also be performed.

As mentioned above, according to the present embodiment, control parameters utilized for image processing are variably adjusted according to amounts of camera movement. As a result, even when camera movement arose, an attempt can be made to enhance image quality. In the present embodiment only the edge enhancement coefficient and the quantization table are variably adjusted. However, other control parameters may also be variably adjusted according to amounts of camera movement, so long as the parameters are control parameters used for image processing susceptible to the influence of camera movement.

### PARTS LIST

10 control section
11 diaphragm member
12 lens
14 CCD
16 CDS circuit
18 AMP circuit
20 analogue-to-digital converter
22 timing generator
24 memory
26 image processing section
28 angular velocity sensor
30 PSF computation section
32 control parameter computation section
34 compression processing section
36 expansion processing section
38 camera shake compensation processing section
42 storage section
44 LCD
46 white balance processing section
48 γ compensation processing section
50 edge enhancement processing section

What is claimed is:

1. An image processing device that subjects captured-image data acquired by means of photographing to predetermined image processing, the device comprising:
a detection unit that detects amounts of camera movement of an image-capturing system during photographing;
a control parameter computation unit that computes a control parameter used for image processing and that computes, from the amounts of camera movement detected by the detection unit, a control parameter which enables lessening of influence of noise in a band where a signal component of an original image acquired in an ideal state has decreased for reasons of the camera movement; and
an image processing unit that subjects the captured-image data to prescribed image processing by use of the computed control parameter.

2. The image processing device according to claim 1, wherein, when the control parameter computation unit computes, as the control parameter, at least an edge enhancement coefficient showing a degree of enhancement in edge enhancement processing in each frequency band, the control parameter computation unit computes, from the detected amounts of camera movement, an edge enhancement coefficient by means of which a decrease arises in a degree of enhancement in a band where the signal component of the original image has decreased for reasons of the camera movement.

3. The image processing device according to claim 2, further comprising:
a PSF computation unit that computes, from the detected amounts of camera movement a PSF showing an amount of movement of an image induced by camera movement; and
a storage unit that stores, as a reference edge enhancement coefficient an edge enhancement coefficient utilized in a state where no camera movement have arisen, wherein
the control parameter computation unit computes an edge enhancement coefficient by means of subjecting the reference edge enhancement coefficient and the PSF to convolution integration.

4. The image processing device according to claim 1, wherein the image processing unit does not perform edge enhancement processing when the detected amounts of camera movement are a given level or more.

5. The image processing device according to claim 1, wherein, when the control parameter computation unit computes, as the control parameter, a quantization table showing quantization values for respective frequency bands in quantization processing for compression processing, the control parameter computation unit computes, from the detected amounts of camera movement, a quantization table by means of which an increase arises in a quantization value in a band where the signal component of the original image has decreased for reasons of the camera movement.

6. The image processing device according to claim 5, further comprising:
a PSF computation unit that computes, from the detected amounts of camera movement, a PSF showing an amount of movement of an image induced by camera movement; and
a storage unit that stores, as a reference quantization table, a quantization table utilized in a state where no camera movement have arisen, wherein
the control parameter computation unit computes a quantization table by means of computing, from the PSF, a degree of decrease in the signal component of the original image attributable to camera movement in each frequency band and compensating for the reference quantization table in order to increase the quantization value in a band where a greater degree of decrease is present.

7. The image processing device according to claim 1, wherein the image processing unit performs camera shake compensation processing for compensating for degradation of an image attributable to camera movement after performance of compression processing of the captured-image data.
